(19) United States
(12) Patent Application Publication
(10) Pub. No.: US 2005/0080811 A1
(43) Pub. Date: Apr. 14, 2005

(54) Configuration management architecture

(75) Inventors: Thomas H. Speeter, San Ramon, CA (US); Marco G. Framba, Cupertino, CA (US); David B. Duncan, Palo Alto, CA (US); Venkateshwar Talla, Secunderabad (IN); Charles A. Bullis, Campbell, CA (US)

Correspondence Address: MORRISON & FOERSTER LLP, 755 PAGE MILL RD, PALO ALTO, CA, 94304-1018, US

(73) Assignee: Cendura Corporation, Mountain View, CA (US)

(21) Appl. No.: 10/920,600

(22) Filed: Aug. 17, 2004

Related U.S. Application Data
(60) Provisional application No. 60/510,590, filed on Oct. 10, 2003.

(51) Int. Cl. G06F 17/00

(52) U.S. Cl. 707/102

(57) ABSTRACT

A system is for managing an application enterprise, wherein the application enterprise includes a plurality of distributed instances of a plurality of applications. The system includes a plurality of application blueprints, each application blueprint modeling a separate application. An enterprise data store is to hold enterprise data, representative of one or more states of the instances, according to the application blueprints. An application enterprise bus provides a standard interface to the enterprise data. A plurality of enterprise data access tools that each access the enterprise data via the application enterprise bus and provide a view of the current state of the application enterprise based thereon.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND

Even experienced development organizations find themselves struggling with the rapid deployment and support of new online technologies. Despite the web's standardizing influence on emerging technologies, the development, deployment and operations processes that evolve around each application are anything but standardized. We refer to the organizations, processes and tools that exist in support of an application as the Application Enterprise. The Application Enterprise includes not only the application itself, but also such things as configuration parameters, data, release notes, deployment tools, operations tools and execution environments, in other words, components that span development, deployment and operations activity.

Effective development teams typically employ experienced staff to properly structure their environments and processes. Tools are selected by development groups (IDEs, source control systems, bug tracking), by operations and support groups (package installation, change management and operational monitoring tools) and by managers (project tracking tools) according to best practices and their individual experiences. However, even if thought can be given ahead of time to the interaction of these tools, they usually become segregated by organization because they are not designed to interoperate. Typically, custom scripts, flat files and informal processes are developed to bridge the gap between development, deployment and operations environments, often in haste as problems are identified. In each Application Enterprise therefore, an assortment of fragile tools and ad-hoc solutions evolve, creating one-of-a-kind environments understood and managed by critical individuals, typically of which there are only a small number. Development and operations teams spend valuable time learning and struggling with the custom components, unable to leverage previous experience with similar tasks.

Compounding this is the lack of documentation and the use of non-standard tools and processes that characterize organizational interfaces in the Application Enterprise. Without standard tools, inefficiencies occur and wheels are reinvented to solve recurring problems. Custom build environments are developed. Informal scripts are written to package and move applications from one environment to another. Flat files are adopted as a means to define configuration parameters and whole teams are assembled to structure, parameterize and propagate applications. Each ad-hoc tool that is written becomes part of the application itself. This often goes unrecognized, leading to poorly or completely undocumented application components. Undocumented tools and processes lead to installation and execution errors. Releases are delayed and downtime increases. Ultimately, thrashing and finger pointing occurs between development, support and operations groups as the failures fall into gaps between the organizations.

Independent Software Vendors (ISVs) that develop complex, configurable products for their customers quickly recognize the importance of structuring their deployments. The ability to parameterize an application, to train customers on the meaning and tuning of those parameters, and the ability to troubleshoot a system after installation are important application features. The challenge for these organizations is to minimize the development and maintenance costs of deployment and maintenance tools. Building infrastructure of this type can defocus an organization from its core development tasks and can significantly inflate the team needed to deliver and maintain a product. Organizations attempt to decrease lifecycle costs by developing robust deployment tools, but the development involved can in the long run drive up costs, adding new components to the system without creating unique value for the product.

Many product organizations recognize the symptoms of process breakdown within the Application Enterprise. Unfortunately, solutions can be as elusive as an understanding of the problem itself.

### BRIEF SUMMARY

Distributed infrastructure for lifecycle management of an application, using a common model of the application A solution is provided that feeds forward information from development to other phases such as, the quality assurance phase to operations and support environments. Status and parameterization is fed back from operating environments, such as, to interested support, QA, and development staff. In all phases, a common model of the application is provided so that participants speak in common terms and use common tools to manipulate application components.

Distributed infrastructure for lifecycle management of an application, using a common model of the application A solution is provided that feeds forward information from development to other phases such as, the quality assurance phase to operations and support environments. Status and parameterization is fed back from operating environments, such as, to interested support, QA, and development staff. In all phases, a common model of the application is provided so that participants speak in common terms and use common tools to manipulate application components.

### BRIEF DESCRIPTION OF THE FIGURES

FIG. 1 illustrates an example Application Enterprise Bus.

FIG. 2 illustrates an example organization of an Application Blueprint.

FIG. 3 illustrates an example organization of a Component Blueprint.

### DETAILED DESCRIPTION

The Application Enterprise Bus (AEB) includes, in some examples, a suite of data models, tools and interfaces integrating development, test, deployment, support and operations tasks. Once exposed to the AEB, an application's structure, parameterization and operating status are visible and manageable by participants in the Application Enterprise. The AEB, for example, provides release management, configuration management, packaging and deployment tools. It facilitates applications to be structured in development, configured in the deployment phase, and moved into an operational environment without custom tools. Once installed, applications can be viewed securely in their operating environment, maintained by support and development staff and troubleshot through a common view onto the system. Operations can integrate monitoring tools to the AEB, enabling them with visibility of application structure and parameterization, while at the same time exposing information from the live system to support and development.

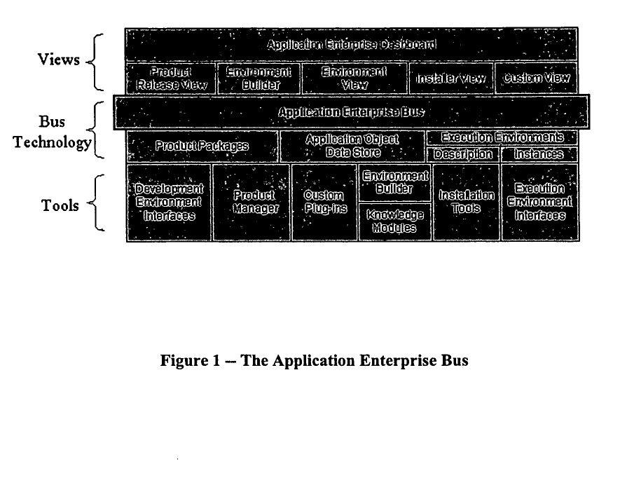

FIG. 1 illustrates an example AEB. In this example, the AEB provides a core set of technologies for organizational interfaces within the Application Enterprise; such as
Product packaging, release management and configuration
Execution environment configuration and management
Product installation, update and adaptation
Product monitoring and troubleshooting

The technical components of the example AEB include:
Data specifications for versioned applications
Product definitions
Modular release packages
Configuration settings
Execution environments
Application Object Data Storage, a persistent store accessible from tools and views on the bus.
APIs for building, parameterizing, modifying, moving and installing product packages
APIs for building, modifying, inspecting and parameterizing execution environments
APIs for inspecting, monitoring and adapting live installed applications

The AEB, like a “traditional bus” operates according to standard interfaces for modular system components. In this case, the system whose interfaces are to be standardized is the Application Enterprise (including development, deployment and operations tasks). The AEB integrates tools and data representations used by IT, support departments, operations and development organizations. Additionally, the bus allows tools to be introduced to bridge the gaps between organizations, providing a unified toolkit and view of application components.

The AEB defines a set of objects, each with its own data model. These objects can be created, viewed and manipulated by tools connected to the AEB. These objects include; for example:
Components (individual software modules, such as a web server or database)
Applications (versioned, configurable combinations of software components)
Host Groups (target environments for the deployment of an application)
Deployments (executing instances of an application on a particular Host Group)

Development organizations maintain strict control over source code, data and known system bugs. It is less common during the development phase to directly consider deployment and operational issues. The AEB, through its interfaces to the development environment, provides the ability to address these issues up front. Deployment and operational factors impacting or caused by the development organization include; for example:
Lack of accurate, timely documentation on application configuration parameters (environment variables, caveats, runtime parameters, tables of data)
Ad-hoc syntax used to define application configuration parameters
Nonstandard management of configuration parameters in a version control system, or storage of configuration parameters outside of the change control process altogether.
Release notes that do not identify application components associated with known issues.
Inability to quickly and accurately create operational execution environments across development, QA, staging and production. This includes network, software and data configurations.
Custom, poorly documented release management tools and processes.
Troubleshooting scripts and debugging insight gathered by the developers (because of deep application knowledge) not exposed to support and operations staff.

To address these issues, the AEB facilitates developers to structure and expose application configuration, scripts, and release notes to the application bus. Developers can identify application assets as they are defined during the development phase. Via integration with the IDE, or through a developer's use of the Product Release View, elements in or outside of the source control system can be identified as deployment assets. After identification, these assets are visible as part of the application object and can be viewed and managed through the on dashboard AEB. Views (i.e. visibility)and actions are available whether the object remains in development, is packaged and about to be deployed, or is deployed and in operation.

Release Management

Applications are typically an assembly of built products (libraries and executables), content, configuration parameters, scripts, policies, third party applications, documentation and supporting files. Product organizations generally have one or more “buildmeisters” who are responsible to schedule builds, manage build products and package the build products as applications for delivery to operational environments. Packages are versioned and correlated with labels or branches in the source control system and bug reports are correlated with the released package. The Product Manager tool is used to organize the packaging, versioning and correlation of application components. It saves the buildmeister from writing custom tools for this purpose, as happens in most development organizations. The Product Manager is a bridge from the AEB to the build, bug tracking, and source control systems. The Product Manager is compatible with common source control applications (ClearCase, CVS, SourceSafe) bug tracking; build technologies, and packaging tools. The Product Manager gathers targets from the build environment, packaging them into an application object that is connectable to the AEB. The Product Manager's packaging is compatible with existing package formats (tar, jar, RPM, InstallShield, CAB, cpio).

The Product Manager is flexible such that it can be connected at whatever level the organization desires or requires. A simple linkage can be set up at first, for example, wrapping existing packages with the Product Manager then using the AEB to move and manage the package to operations. With time, more functions can be migrated to the Product Manager, making more elements of the application visible to the AEB. Flexibility of the interface and the ability to evolve integration of release processes to the AEB are desirable features of the Product Manager.

Propagation Policies

Applications are characterized by policies that define a way to move them between build and execution environments (development, QA, staging, operations). Policies, such as check-offs from one group to another, tracking of issues and documentation of application status can be organized and managed through the Product Manager. When products are ready for deployment (using the Installer, see below), policies are enforced and movement activities are tracked and can be audited.

A deployed application is a packaged product, configured and deployed to an execution environment. The target host group may include, for example, various types of servers, network elements, storage, data and supporting software components. Structured deployment of a package to a target environment uses an environment description, and typically assumes that the incoming package is sized and parameterized for that environment. The interface between development and operations with respect to product deployment is typically unique for each product, worked out between the groups according to each one's capabilities. Sometimes complete system images are delivered to operations; sometimes only data, content and a few executables are delivered, and IT or operations sets up system components (hardware and/or software) to support the product. In most cases, a deployment team adds parameterization to the product as it is moved into production, to specifically configure it for the target execution environment.

The ability to define an execution environment and to inspect the implementation of the definition (for example to verify it) is provided by the Execution Environment Builder. Using a common view through the Application Enterprise Dashboard, development, support and operations staff can see and understand the target environment and visualize how an application package maps onto it. Parameterization can move in both directions, facilitating developers to define and document configurations to operations and support, while enabling the export of operational configurations to development and support environments. This addresses a fundamental set of issues that arise between development, support and operations; such as:
Inability to clearly define what an environment includes.
Inability to setup and duplicate environments from one machine/set of machines to another.
Inability to quickly verify that an environment is configured according to its specification.
Inability to answer the question . . . ‘what changed in the environment?’.

Component Blueprints are supplied for the construction of execution environments, allowing drag-drop style definition of target systems. Component Blueprints provide built in knowledge of component structure, installed footprint, dependencies, and parameterization for system setup and tuning. Component Blueprints are defined for all layers, from hardware, networking, firewalls, to load-balancers, operating systems (NT, Win2000, Unix), application platforms (Net, J2EE, ), web-servers (IIS, Apache, iPlanet), databases (Oracle, SQL Server, DB2) and application suites (SAP, PeopleSoft, Siebel). Once defined, application components and configuration parameters can be viewed, queried and modified through the Application Enterprise Dashboard.

Installation Tools

The Installer moves application packages and their parameterization and updates from the development or deployment environment to an operations environment. Often a firewall is in place between these organizations to prevent un-audited modification of executing software, or to prevent non-operations staff from accessing data in the operations environment. The Installer provides secure, audited movement of packages to operations and ensures proper deployment of products to selected machines.

Many issues associated with application configuration and installation are addressed by the Installer.
Exposition of configuration parameters and application structure to the deployment team. Access is through a common view available to development, deployment and operations staff.
Explicit visibility and management of data, scripts and configuration files as part of the installation process.
Provides auditable, secure movement of application packages and data to the target environment.
Allows the definition of an installation workflow, including an order of actions, running of scripts, and check-pointing along the way.
Allows installation ‘dry-runs’ for testing application deployment without actually installing components to the target environment.
Provides a verifiable inventory of all installed components.
Provides transactional install, update and adaptation capabilities.
Provides structured ‘bring-up’ of application components.
Tracks the update and adaptation of an application once it is installed.
Makes the installed application and its operational environment visible and manageable, through the AEB.

The Installer in conjunction with the Release Manager implements transactional installation/deinstallation, roll-in/roll-out of patches and tuning of parameters in such a way that changes are recognized and automatically organized into deployment patches

Releases are application versions managed by the Release Manager. One step in the workflow of application installation is the check-off that exposes a version as a Release. This function is reversible, allowing a release to be decommissioned when it is obsolete, or withdrawn as an installation candidate if problems are discovered.

Once checked off, the Installer is employed to install a Release to one or more execution environments. The installation process combines a Product application object with an Environment object to map the virtual application to a specific target. At this time, configuration parameters identified by development are visible to the deployment team through the Installation View. Data, environment variables, runtime parameters and other configuration can be populated and verified. Once the configuration has been specified and verified, installation can take place. This involves securely moving application components to their targets, placing components where they belong and verifying that all of the parts are accounted for and are in place. Installation may include the placement of application products on a configured server, or complete imaging of the servers with applications components included. The Installer operates in either mode. Installation workflows can be defined, ordering the installation of components, running scripts, and prompting for feedback during the process. Because installations are transactional, they can be aborted and rolled back at any point in the workflow.

After component installation, a common problem is inability to ‘bring the system up’. This may be due to application misconfiguration, missing components, bad data, hardware/network failure, software version incompatibilities or other problems. The Installer and Development Interfaces can help to structure an application so that misconfiguration and missing components are minimized or eliminated. But beyond application structuring, the Installer allows OS independent application bring-up to be scripted, and made visible to the AEB. The Installer handles security and OS specific tasks on installation, allowing the application to be activated and deactivated from the Installer View. The Activation step is often overlooked until an application is first deployed and it becomes the operations team's task to script system bring up and debug problems as they occur. By explicitly defining Activation as an application component and by providing tools to structure and automate the process, Cendura fills a critical gap in the Application Enterprise is filled.

Updating installed systems and tuning application parameters are common, although not always well structured, tasks in the Application Enterprise. Through product definition with the Release Manager, partial updates are applied to installed system, using similar (if not the same) process and interfaces as installation. The Installer optimizes updates by installing only those components that have changed, speeding the deployment of patches, thus minimizing downtime for updates.

The tuning of installed applications is called adaptation. Many parts of an application are tunable, including parameters from hardware, OS, application and network levels. Both the Installer View and Environment View facilitate enabled users to view and modify parameters that have been exposed to the AEB. All changes are recorded for auditability, and may be rolled back if needed. This capability addresses two fundamental issues in the Application Enterprise. First, explicit definition of tunable parameters helps to document the variables that control application behavior. Second, auditable control over adaptation keeps undocumented changed from creeping into the system, giving operators confidence to allow support and development staff access to the system for troubleshooting.

Data model of an application—abstract blueprint.

(a) Layered, with nesting.

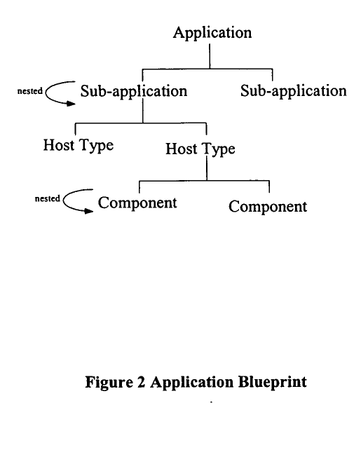

FIG. 2 illustrates an example organization of an Application Blueprint.

The Application Blueprint describes the generic structure of a software application. It is an abstract model that is not specific to a particular deployed instance. The application may at first be decomposed into (potentially nested) sub-applications. Sub-applications are independent units within the larger application structure, that may be separately maintained or released within the Application Enterprise. For example a billing system or streaming video capability may be considered a sub-application within a larger customer facing service. Within the sub-application (or the application, if no sub applications exist), specific host types are identified. Distributed applications typically have different types of computational servers performing specialized functions such as serving web pages or acting as a database server. Each host type has a set of associated components, potentially nested.

The application blueprint data model represents the structure shown in FIG. 2, in addition to rules defining whether elements in the model are required, have dependencies on one another, have version dependencies or other rules constraining the eventually deployed image of the application.

Component Blueprint

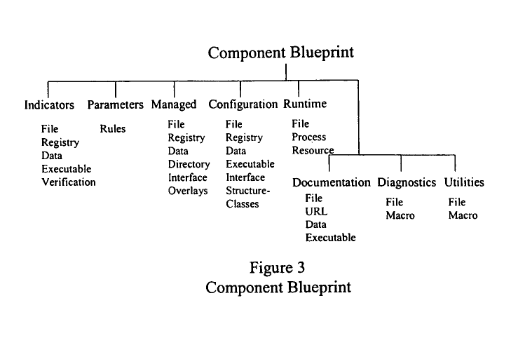

The component blueprint, an example of which is illustrated in FIG. 3, provides a data model for an individual software component. Indicators provide rules, based on the presence, location and relative values of files, registry variables, data, or executable output, for how to locate an installed instance of the software module. Verification rules allow the discovery to be verified if there may be ambiguity. Parameters are rules for the calculation of important values, such as the location where the component is installed, or its version.

The Managed container holds rules for determining the ‘parts-list’ of the component, identifying all of the pieces belonging to the component, including files, data, registry values, directory server sub-trees or other resources available through interfaces. Overlays can be provided that define rules, annotation and categorization of individual managed elements.

The Configuration container enumerates and defines all of the configuration ‘knobs’ for the component. Structure classes can be provided that define how to parse configuration information, rules, annotation and interpretive information for each configuration element.

The Runtime container identifies the components runtime signature, including processes, log files and other resources uses or modified while the component is running.

The Documentation container collects documentation from the component vendor into one location. This includes files, web pages, data and the output of executables.

The Diagnostics and Utilities containers organize executables that can be used to respectively administer or troubleshoot the component. Executables and scripts are exposed, along with common parameterizations as Diagnostics/Utility files. Sequences of actions and conditional logic can be chained together as Macros, allowing typically sequential activities to be gathered together and executed as a unit.

Elements in the blueprint can be categorized and weighted. Categorization facilitates any number of descriptors such as “Security” or “Performance” to be associated with an element. These act as attributes that can be queried for during operations executed against a discovered component. Weights allow the importance of elements in the blueprint to be identified. This allows operations on discovered components to be tuned so that only the most relevant elements are considered.

Software components can be defined using the same component blueprint data model. This normalization process facilitates all components to be stored and viewed similarly. Users not familiar with a given component are able to find and work with information in the model because of this normalization.

2. Discovery

Discovery is the process of locating installed components and applications on a set of hosts. The mechanism of discovery is to, in parallel, query an agent software process running on each host that is to be interrogated. The agent process looks for the indicators defined in the component blueprints and reports the results back to a centralized server. At the centralized server, results from all of the agents are correlated into a complete image of the deployment. The results of discovery are stored in a database from which they can be retrieved, viewed and updated.
(i) One form of discovery uses an Application Blueprint to guide the discovery process. The Application Blueprint defines a set of components for which search. Each Component Blueprint defines how the corresponding component is to be located and verified. Once components are verified, host types and sub applications are identified according to the rules in the Application Blueprint. When discovered, the deployed application is called a ‘Deployment’. Rules within the Application Blueprint can be used to discard components that violate the Application Blueprint. For example, components that are at a certain location in the file system will be discarded if they are not found at that location.
(ii) A second form of discovery does not use an Application Blueprint. Instead, a set of components is chosen, without identifying host type, or sub application information. The components are located in the same manner as (i), but when completed, the discovery process automatically builds an Application Blueprint from the list of discovered components. The generated Application Blueprint can be augmented with rules and additional structure so that it can be subsequently used for type (i) discoveries.
   3. Operations

(a) Refresh

After a deployment has been discovered, elements among the managed components may change. For example files may be moved or configuration parameters may be updated. To get a current image of the deployment, and to update the stored deployment image in the database, the deployment may be refreshed. During refresh, agents on each managed host are asked to review all of the managed components, and report differences to the server. The time stamped, updated deployment image is stored in place of the previous deployment image.

(b) Snapshot

To retain an image of a discovered deployment, so that refresh operations do not cause historical information to be lost, a snapshot can be taken. A snapshot causes a duplicate copy of the deployment image to be created in a database. This image is marked as a snapshot and subsequently cannot be modified, since it is a historical record that should remain unchanged from the time that the snapshot is taken.

(c) Compare

Comparison can be used to determine if a deployment is drifting away from a standardized configuration (a gold-standard or template), or it can be used to investigate the difference between different deployments, or the same deployment across time.
(i) Comparisons of deployment images can be made across time and across space. A deployment image can be compared against a historical snapshot of the same deployment, or two snapshots of the same deployment can be compared. These are considered to be “across time” since they are images of the same thing, only at different points in time. Alternatively, two entirely different deployments can be compared against one another. For example, an image or snapshot taken from a staging environment can be compared to an image or snapshot taken from a production environment. These are considered “across space” since they are images of deployment on different hosts, located in different places.
(ii) Comparisons can be made at multiple levels in the application blueprint hierarchy. Comparison can be deployment/snapshot to deployment/snapshot, or can be sub-application to sub-application, host to host, or module to module, for example. Comparisons that are host to host or module to module can either be one-to-one, or one-to-many. For example, one host can be compared against one other host. In the one to many case, for example, one module on one host can be compared to many other modules on the same or other hosts. Comparisons made at different levels can either be across time or across space.
(iii) An important factor to consider when making comparisons is the comparison signal-to-noise ratio (SNR). The SNR is a measure of how many relevant differences are discovered divided by the number of irrelevant differences that are reported. A relevant difference is one that has important consequences or is of interest to member of the application enterprise for ongoing operational or support reasons. For example, to report that a log file changes size is not important, since it is expected and normally unimportant. But if a key executable file is missing, that is important. The higher the SNR the more useful the comparison. To raise the SNR, the number of irrelevant differences should be lowered. To accomplish this, the categorizations and weighting defined in the Component Blueprints are used. The user can limit the number of irrelevant differences detected by narrowing the scope of the difference operations. By choosing weights and categories to consider, or by excluding certain weights and categories from consideration the user can tune the operation so that fewer irrelevant differences are reported. In addition, the system automatically applies filters based on the type of comparison selected. If comparison across time is selected, then elements that are expected to vary with time are not compared. Examples of these include log file sizes and usage counters. If comparison across space is selected then items that are expected to vary between different deployments are ignored. Examples of these include file creation and modification time stamps and host names.

(d) Verification

Verification is the process of running rules that have been defined on the elements of a deployment image or snapshot. Rules are Boolean expressions involving the value of one or more elements, or the values of element attributes. All elements in a deployment have a value (for example the value of a registry key is its defined value), and all elements have attributes, which are name-value pairs (for example a managed file has an attribute called size, which is the number of bytes in the file).

Rules are used to define a set of constraints on the deployment image. They can limit a value, or constrain one value relative to another. All rules return a Boolean result, true or false. Rules are assigned a severity, allowing selection at verification time of the severity level or rules to run.

Rules can be defined in the component blueprint, or a rule can be defined directly on the deployment. If defined on the blueprint, the rule is attached to the deployment when it is discovered. Many rules are automatically generated, and these are called implicit rules. Implicit rules are created from data type restrictions and default value specification. When an element has it's data type defined in a component blueprint, a rule is generated that will fail if the value of that element does not conform to the data type. If an element has a default value (a value that the system will use if no other value is defined, for example in a configuration file), then an implicit default value rule will be generated.

When verification is rule, a severity level is chosen, and type set of rules to execute is defined. One constraint on the set of rules to rule is the rule type. Rule types include Component Blueprint rules, Deployment rules, and default value Rules.

(e) Export/Import

In addition to a common data model, a portable representation of the model and its contents is defined. The portable format allows deployment images to be exported from one data store, and imported to another. An exported blueprint, deployment or snapshot image is represented in a single file that can be encrypted and easily be moved from one location to another. This allows comparison and verification to take place away from the actual physical location of the deployment. ISVs for example can utilize this capability to take exported images of customer installations and import them within their support organizations to help troubleshoot problems. The export format can also be used for archiving since it is a space efficient representation of the deployment image.

(f) Communication

The deployment image can be used as a communication tool that binds together members of the Application Enterprise. Links into the image can be embedded into conventional communication tools, like e-mail so that co-workers can communicate effectively about the exact location of issues within the deployment image. Notes and rules can be attached to the application and component blueprints, or do deployment images allowing members to annotate the application with information at precise locations within the data model.

Organizations outside of development and operations (for example finance, marketing or sales) may require visibility to portions of the Application Enterprise. Even customers may want access so that they can verify application parameters, verify system functions and ‘feel comfortable’ that their applications are running and are well managed. Via a secured Custom View, guests, customers and/or other users can be granted access to any or all products and execution environments plugged into the Application Enterprise Bus. This is a powerful extension, allowing controlled and auditable access to what is conventionally a closed environment. Access control can be configured so that only selected objects are visible and selected operations are enabled.

A common view shared by all associated organizations and customers helps to expedite troubleshooting during periods of application instability, helps all parties to plan future releases and strategies, and provides a common vocabulary and understanding of how the application runs and how it is developed and released.

From both the development and operations environments, the open interfaces of Application Enterprise Bus allow integration of all parts of an Application Enterprise into a common view. Project management, Schema and OO design tools can be plugged into the bus via standard interfaces. Schema design, for example can be used to provide operations staff and DBAs a sophisticated view of database, triggers, stored procedures and constraints that they would otherwise not be afforded. Alternatively, operational tools (e.g. HP OpenView, Tivioli, Unicenter) can be integrated into the bus, providing developers a view onto the running system. Because these custom tools are accessed through the Application Enterprise Bus, the applications associated with each capability do not have to be installed (saving license costs). The Application Enterprise Bus can be used effectively as an application integration platform.

Custom tools can also be plugged into the Application Enterprise Bus. For example an interface could be developed that allows managers or customers to request summaries of source control system activity, correlated with filed bugs. The custom plug-in would in this case consist of a wrapper around scripts executed against the source control and bug tracking systems.

4. Security

(a) Access Control to the Schema

Access control is configurable to restrict views and/or application objects across the user base. Well-managed security implementations require that policy be coherent and fully documented by a team of security experts. While it is often the case that policies are documented, it is rarely true that implementation of the policy can be accurately or conveniently tracked. The Product Manager allows security policies and associated parameterizations to be defined, viewed and managed from a single interface. This provides a powerful capability to centralize security policy, allowing only those individuals responsible for and knowledgeable of the policies to control their implementation. The security policy of an application can be audited from a single place and those responsible for security within an organization can be assured that the policy is defined and implemented correctly

(b) Access Control to Application Object

Users within the Application Enterprise have different needs and restrictions as they view and act on deployment images. Users can be restricted to read, write, or execute access on any object or function within the deployment image. Access can also be controlled to the meta-data, for example the building and modification of application and component blueprints.

(c) Integrate with Existing Security—e.g., Directory Services

Users within the Application Enterprise can be configured and given permissions by an administrator as they are imported from the organization's enterprise directory (e.g. LDAP).

5. Transactional Operations

Because the application enterprise bus federates the Application Enterprise, operations can be transactionally performed across the enterprise in way not previously possible. Transactional operations are actions on the deployment or deployment image that conform to the well-known ACID properties of transactions. That is, they are (a) Atomic, all parts of the operation happen, or all do not, (b) Consistent, the target of a transaction remains in a consistent state before and after the transaction, (c) Isolation, the transaction is isolated from other activity or other transactions in the system and (d) Durable, once completed and committed, the changed caused by the transaction are permanent. An important feature of transactions is ‘rollback’, allowing changes to be removed before they are committed to the system.

Transactions across the deployment are enabled by federations and aided by the underlying data model. The transactional operations enabled include
(A) Replication: using the results of a compare operation, deployments, hosts and components, or any element within a component can be made identical, across time and space. Differences detected during comparison are transactionally made the same. All differences are made with ACID properties, and can be rolled back if not appropriate.
(B) Repair: using the results of a verify operation, deployment, host, or component structure, or element values and attributes values can be made compliant to rules in a single transactional operation.
(C) Installation, update, tuning: Installation of entire applications, using the application blueprint as a guide can be transactionally performed across any group of hosts in the Application Enterprise. Update of installed applications, including file, data, registry, configuration or other element changes can be transactionally executed using a patch blueprint, defining the elements to be changed, sequencing and rollback information. Tuning involves minor change to configuration, and is like update, but limited to configuration parameters.

1. A system for managing an application enterprise, wherein the application enterprise includes a plurality of distributed instances of a plurality of applications, comprising:
a plurality of application blueprints, each application blueprint modeling a separate application;
an enterprise data store to hold enterprise data, representative of one or more states of the instances, according to the application blueprints;
an application enterprise bus providing a standard interface to the enterprise data; and
a plurality of enterprise data access tools that each access the enterprise data via the application enterprise bus and provide a view of the current state of the application enterprise based thereon.

2. The system of claim 1, wherein the enterprise data access tools include organizational tools for managing the applications and the application instances.

3. The system of claim 2, wherein:
the application enterprise bus defines a plurality of objects, each object characterized by a separate data model view of the application enterprise bus; and
the enterprise data access tools operate on the objects.

4. The system of claim 2, wherein:
the organization tools include a tool to communicate at least one image of the application instances between the system and processes outside the system.

5. The system of claim 4, wherein:
the tool to communicate the at least one image communicates the at least one image in a portable data format.

6. The system of claim 3, wherein:
the enterprise data access tools operating on the objects collectively accomplish management of the application enterprise.

7. The system of claim 1, wherein:
at least one of the applications includes at least one associated component;
the at least one associated component is modeled by a component blueprint.

8. The system of claim 7, wherein:
the component blueprint is referred to by the application blueprint modeling the application including the component.

9. The system of claim 1, wherein:
the application blueprints identify host types, and each host type is characterized by at least one associated component.

10. The system of claim 9, wherein:
the application blueprints further include rules characterizing interactions between the components.

11. The system of claim 9, wherein:
the at least one associated component being modeled by a component blueprint includes the component blueprint providing a data model of the associated component.

12. The system of claim 11, wherein:
the component blueprint includes categorizations and weights associated with the data elements in the associated component data model.

13. The system of claim 2, further comprising:
means for discovering installed components and applications on computational devices.

14. The system of claim 13, wherein:
the discovering means includes at least one agent process.

15. The system of claim 14, wherein:
wherein the at least one agent process is associated with at least one of the computational devices and, based on rules in the component blueprints, is configured to provide information about the components for that at least one associated computational device.

16. The system of claim 15, further comprising:
a discovery process configured to interact with the at least one agent process to coordinate execution of the at least one agent process and to correlate information provided by the at least one agent process to generate an image of the application instances.

17. The system of claim 16, wherein:
the discovery process is configured to search for components in the application enterprise based on at least one of the application blueprints.

18. The system of claim 17, wherein:
the at least one of the application blueprints includes component blueprints, and
searching for components in the application enterprise includes locating and verifying components based on the component blueprints included in the at least one of the application blueprints.

19. The system of claim 16, wherein:
the discovery process is configured to
search for and find components in the application enterprise without regard for particular applications to which the components belong; and
in addition to generating the image of the application instances, build at least one application blueprint based on the found components.

20. The system of claim 16, further comprising:
a refresh process configured to search for changes in the components of the application enterprise from an execution of a previous refresh process or discovery process.

21. The system of claim 16, further comprising:
an archive process configured to archive the image of the application images as a snapshot image.

22. The system of claim 2, further comprising:
a compare process configured to compare a first image of the application instances to a second image of the application instances.

23. The system of claim 22, wherein:
the first image of the application instances and the second images of the application instances are image of the same application instances, at different times.

24. The system of claim 22, wherein:
the first image of the application instances and the second image of the application instances are images of different application instances.

25. The system of claim 22, wherein:
the compare process is configured to compare images of application instances across space.

26. The system of claim 2, further comprising:
a compare process configured to compare a first portion of an image of the application instances to a second portion of the same image of the application instances.

27. The system of claim 22, wherein:
the component blueprint includes an indication of weighting and categories usable to tune the comparison.

28. The system of claim 22, wherein:
the component blueprint is configured to indicate relative importance of differences found during execution of the compare process.

29. The system of claim 28, wherein:
the differences are weighted and categorized according to the component blueprint configuration.

30. The system of claim 2, further comprising:
a process configured to discover elements of a deployment and to generate an image of the application instances based thereon; and
a verification process configured to process the image of the application instances to verify compliance with a plurality of rules.

31. The system of claim 30, wherein:
the rules define constraints on the deployment.

32. The system of claim 31, wherein:
the constraints on the deployment include limitations on values of characteristics of the deployment.

33. The system of claim 32, wherein:
the constraints on the deployment include limitations on a particular value of a characteristic relative to values of other characteristics.

34. The system of claim 31, wherein:
the rules are characterized by a severity level.

35. The system of claim 30, wherein:
the rules are defined in at the component blueprint.

36. The system of claim 35, wherein:
at least some of the rules are defined by implication based on restrictions and specifications in the component blueprint.

37. The system of claim 2, further comprising:
a process to export an image of the application instances from the system.

38. The system of claim 2, further comprising:
communication tools configured to provide multiple users access to addressable portions of an image of the application instances.

39. The system of claim 38, wherein:
the communication tools include e-mail configured to include a link to the addressable portions of the image of the application instances.

40. The system of claim 38, wherein:
the communications tools include tools to correspond notes and rules to addressable portions of the image of the application instances.

41. The system of claim 2, further comprising:
a process configured to process an image of the application instances to provide a view of the application enterprise configured to a particular user.

42. The system of claim 41, wherein:
the process configured to process the image of the application instances to provide a view of the application enterprise includes processing to control access to particular portions of the image of the application instances based on predetermined functional constraints.

43. The system of claim 42, wherein:
the functional constraints are based on characteristics associated with a particular user.

44. The system of claim 42, wherein:
the functional constraints are based on characteristics associated with a particular function.

45. The system of claim 2, further comprising:
an integrated process configured to process the image of the application instances according to a standard interface.

46. The system of claim 45, wherein:
the integrated process is configured to provide data to the image of the application instances.

47. The system of claim 45, wherein:
the integrated process is configured to accept data from the image of the application instances.

48. The system of claim 42, wherein:
the processing to control access to particular portions of the image of the application instances is driven by data in an enterprise directory.

49. The system of claim 2, further comprising:
a process for accomplishing transactions across the application enterprise.

50. The system of claim 49, wherein:
the process for accomplishing transactions includes a process to accomplish a replication operation.

51. The system of claim 50, wherein:
the replication operation is based on an image of the application instances.

52. The system of claim 51, wherein:
the replication operation being based on an image of the application instances includes the replication operation being based on differences determined as a result of a comparison between at least two images of the application instances.

53. The system of claim 49, wherein:
the process for accomplishing transactions includes a process to accomplish a repair operation.

54. The system of claim 53, wherein:
the repair operation is based on an image of the application instances.

55. The system of claim 54, wherein:
the repair operation being based on an image of the application instances includes the repair operation being based on non-compliance to rules associated with the application blueprints.

56. The system of claim 49, wherein:
the process for accomplishing transactions includes a process to accomplish an installation operation.

57. The system of claim 56, wherein:
the installation operation is based on the application blueprints.

58. The system of claim 49, wherein:
the process for accomplishing transactions includes a process to change parameters associated with the applications.

59. The system of claim 58, wherein:
the process to change parameters associated with the applications is an update transaction.

60. The system of claim 59, wherein:
the update transaction operates based on a patch blueprint.

61. The system of claim 49, wherein:
the process to change parameters associated with applications is a tuning transaction.

62. The system of claim 61, wherein:
the tuning transaction operations to change configuration parameters only.
